(19) United States
(12) Patent Application Publication
(10) Pub. No.: US 2019/0292502 A1
(43) Pub. Date: Sep. 26, 2019

(54) POURING SPOUT FOR BOTTLED LIQUIDS

(71) Applicant: Andrew Leverich, Holt, MI (US)

(72) Inventor: Andrew Leverich, Holt, MI (US)

(21) Appl. No.: 15/935,157

(22) Filed: Mar. 26, 2018

(51) Int. Cl. C12H 1/07; B65D 25/42; B01D 24/10; B01D 35/02; B01D 39/06

(52) U.S. Cl. CPC C12H 1/063; B65D 25/42; B01D 39/06; B01D 35/02; B01D 24/10

(57) ABSTRACT

A pouring spout used to filter bottled liquids as they are poured from a bottle containing such liquids.

### BACKGROUND OF THE INVENTION

The applicant is unaware of any prior art.

### THE INVENTION

The present invention is a filtration pouring spout for bottled liquids. The pouring spout comprises an elongated hollow housing. This elongated hollow housing has a top end and a bottom end. Each of the ends are open.

This invention deals with a filtration pouring spout for bottled liquids. The pouring spout comprises an elongated hollow housing. The elongated hollow housing has a top end and a bottom end and each end is open.

The elongated hollow housing has an open removable cap on each end and each removable cap has contained in it a mesh screen. There are retainer lips mounted on the interior surface of each removable cap.

There is a flexible plug surmounting the top end of the elongated hollow housing. There is a pouring spout surmounted on a top end of the flexible plug, and the flexible plug has a top opening and a bottom opening. The pouring spout has a top end and a base and the top end of the pouring spout is bent a predetermined distance from the vertical. The base has a vacuum release opening through it.

There is a vacuum release tube, the vacuum release tube is mounted in the vacuum release opening such that a predetermined length of the vacuum release tube extends above the base and is bent a predetermined distance from vertical, and 180° from the bend in the spout.

The vacuum release tube extends a predetermined distance on an outside surface of the elongated hollow housing.

There is a carbon filled cartridge fitted to the inside of the elongated hollow housing and it extends a predetermined distance inside of the elongated hollow housing.

### BRIEF DESCRIPTION OF THE DRAWING

FIG. 1 is a full side view of the spout.

FIG. 2 is a view in perspective of the top cap of the elongated housing.

FIG. 3 is a view in perspective of the bottom cap of the elongated housing.

FIG. 4 is a cross sectional view through line A-A of FIG. 1.

FIG. 5 is a cross sectional view through line B-B of FIG. 2.

FIG. 6 is a cross sectional view through line C-C of FIG. 3.

### DETAILED DESCRIPTION OF THE DRAWINGS

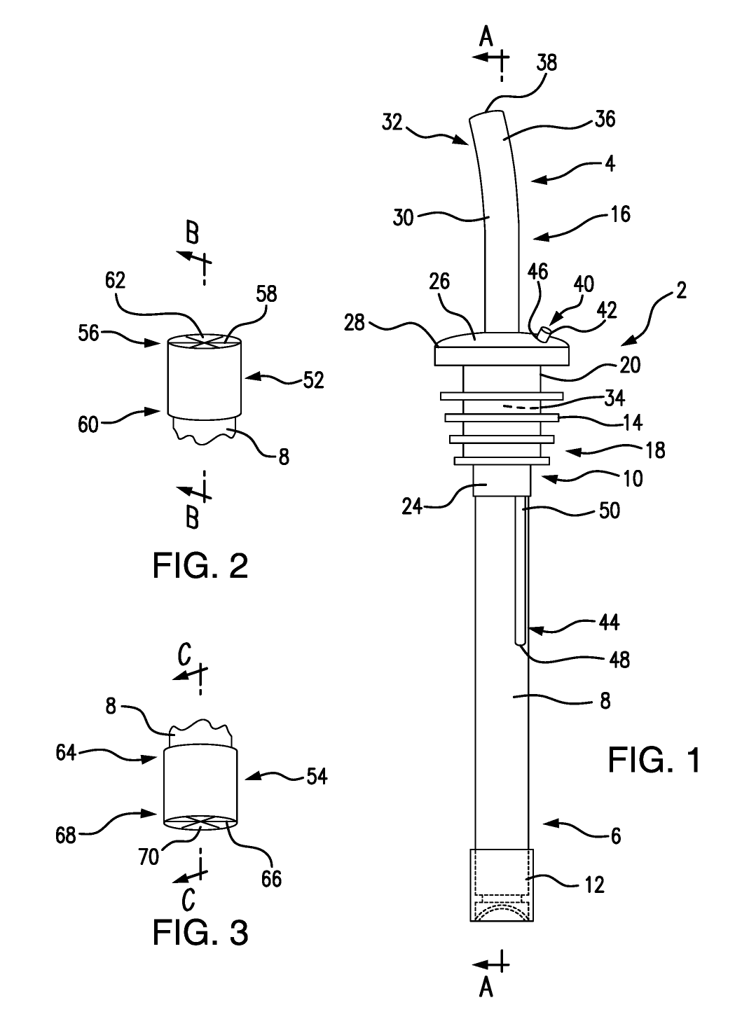

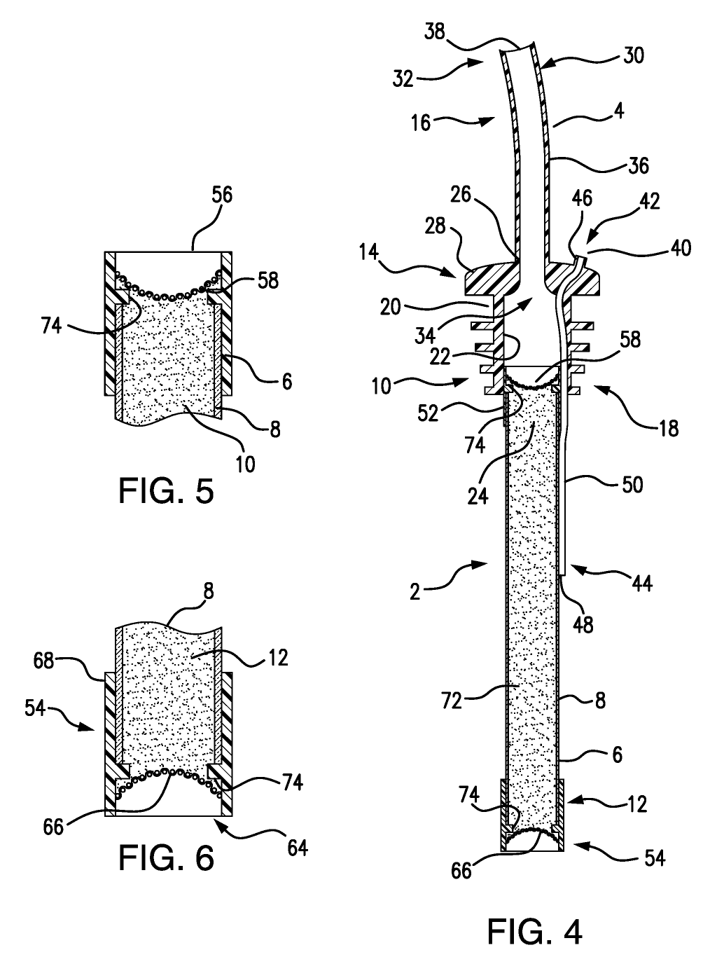

FIG. 1 is a full side view of the pouring spout 2 with line A-A bisecting the pouring spout 2. The pouring spout 2 has a top end 4 and a bottom end 6. The pouring spout 2 has an elongated portion 8. This elongated portion 8 has a top end 10 and a bottom end 12. The flexible plug 14 has a top end 16 and a bottom end 18. The top of the elongated housing 8 is inserted into the bottom of the flexible plug 14. The flexible plug 14 has an outside surface 20 and an inside surface 22 (shown in FIG. 4). The flexible plug 14 also has a top opening 26 and a bottom opening 24. The flexible plug 14 also has a top surface 28.

The flexible plug 14 also has a pour spout 30 inserted into it at the top opening 26 and extends through the top surface 28. The pour spout 30 has a top end 32 and a bottom end 34. The pour spout 30 has a predetermined angle 36 and an opening therethrough 38.

The flexible plug 14 also has an air vent 40. The air vent 40 has a top end 42 and a bottom end 44. The vacuum release tube 40 also has a predetermined angle 46. The angle 46 of the vacuum release tube 40 is diametrically opposed to the angle 36 of the pour spout 30. The vacuum release tube 40 also has an opening 48 through it and a middle portion 50.

It has been discovered that the flexible plug 14 has been designed to fit snuggly into a bottle of liquid, such as a bottle of alcohol. With the pouring spout 2 inserted into the bottle of alcohol the bottle is tipped to dispense some of the contents. During the pouring procedure the alcohol flows through the charcoal 72 that is in the elongated housing 8, filtering it. The charcoal 72 is a distiller's grade charcoal.

FIG. 2 shows the top cap 52 of the elongated housing 8 with line B-B bisecting the top cap 52 of the elongated housing 8. The top cap 52 has a top end 56 and a bottom end 60. Just below the top end 56 of the top cap 52 is a mesh 58. The mesh has an average opening of about 0.0203 mm. and the mesh can be anywhere from about 0.0100 to about 0.0300. The top cap 52 has an opening 62 through it.

FIG. 3 shows the bottom cap 54 of the elongated housing 8 with line C-C bisecting the bottom cap 54 of the elongated housing 8. The bottom cap 54 has a top end 64 and a bottom end 68. Just below the bottom end 68 of the bottom cap 54 is a mesh screen 66. The bottom cap 54 has an opening 70 through it.

FIG. 4 shows the pouring spout 2 bisected by line A-A. This Figure shows the inside of the pouring spout 2 along line A-A bisecting the pouring spout 2. The pouring spout 2 has a top end 4 and a bottom end 6. The pouring spout 2 has an elongated portion 8. This elongated portion 8 has a top end 10 and a bottom end 12. The elongated housing 8 is inserted into the flexible plug 14. The flexible plug 14 has top end 16 and a bottom end 18. This flexible plug 14 has an outside surface 20 and an inside surface 22 (shown in FIG. 4). The flexible plug 14 also has a top opening 26 and a bottom opening 24. The flexible plug 14 also has a top surface 28.

The flexible plug 14 also has a pour spout 30 inserted into it at the top opening 26 and extends through the top surface 28. The pour spout 30 has a top end 32 and a bottom end 34. The pour spout 30 has an angle 36 and an opening therethrough 38.

The flexible plug 14 also has an air vent 40. The air vent 40 has a top end 42 and a bottom end 44. The vacuum release tube 40 also has an angle 46. The angle 46 of the vacuum release tube 40 is diametrically opposed to the angle 36 of the pour spout 30. The vacuum release tube 40 also has an opening therethrough 48 and a middle portion 50.

The top end cap 52 has a mesh 58 and the bottom end cap 54 also has a mesh 66 that are held in place by lips 74. The elongated housing 8 is filled with charcoal 72 that acts as a filter. It has been discovered that the charcoal filters unwanted tastes from the alcohol that is being poured through the pouring spout 2.

Also shown here is a vacuum release tube 40 which allows air to flow into the alcohol bottle as alcohol is poured out. The pour spout 30 is angled in one direction while the vacuum release tube 40 angles in the other direction preventing the flow of the alcohol through the vacuum release system.

FIG. 5 shows the pouring spout 2 top end cap 52 bisected by line B-B. The top end cap 52 has top 56, the mesh 58, the bottom 60 and the lips 74 that hold the mesh 58 in place. Also shown is the top end 10 of the elongated housing 8.

FIG. 6 shows the pouring spout 2 bottom end cap 54 bisected by line C-C. The bottom end cap 54 has a top 64, a mesh 66, a bottom 68 and the lips 74 that holds the mesh 66 in place. Also shown is the bottom end 12 of the elongated housing 8.

The mesh 58 and 66 is fine enough to prevent any of the charcoal 72 from leaving the elongated housing 8.

What is claimed is:

1. A filtration pouring spout for bottled liquids, said pouring spout comprising:
A. an elongated hollow housing, said elongated hollow housing having a top end and a bottom end, each said end being open;
B. said elongated hollow housing having an open removable cap on each end thereof, each said removable cap having contained therein a mesh screen, there being retainer lips mounted on the interior surface of each said removable cap;
C. a flexible plug surmounting said top end of said elongated hollow housing;
D. a pouring spout surmounted on a top end of said flexible plug, said flexible plug having a top opening and a bottom opening, said pouring spout having a top end and a base, said top end of said pouring spout being bent a predetermined distance from the vertical, said base having a vacuum release opening therethrough;
E. a vacuum release tube, said vacuum release tube mounted in said vacuum release opening such that a predetermined length of said vacuum release tube extends above said base and is bent a predetermined distance from vertical, and 180° from said bend in said spout;
F. said vacuum release tube extending a predetermined distance on an outside surface of said elongated hollow housing;
G. a carbon filled cartridge fitted to the inside of said elongated hollow housing and extending a predetermined distance inside of said elongated hollow housing.
